(19) United States
(12) Patent Application Publication
(10) Pub. No.: US 2026/0270783 A1
(43) Pub. Date: Sep. 10, 2026

(54) WIRELESS COMMUNICATION APPARATUS AND WIRELESS COMMUNICATION SYSTEM

(71) Applicant: SONY SEMICONDUCTOR SOLUTIONS CORPORATION, KANAGAWA (JP)

(72) Inventors: KATSUYA SHINOZAKI, KANAGAWA (JP); ATSUSHI MORI, KANAGAWA (JP); TAKUYA MIYASHITA, KANAGAWA (JP)

(21) Appl. No.: 19/160,867

(22) PCT Filed: Jan. 26, 2024
(86) PCT No.: PCT/JP2024/002407

§ 371 Date: Aug. 29, 2025

(30) Foreign Application Priority Data
Mar. 23, 2023 (JP) 2023-046889

(51) Int. Cl. H04W 28/06; H04W 4/06; H04W 24/02; H04W 84/10

(52) U.S. Cl. CPC H04W 28/065; H04W 4/06; H04W 24/02; H04W 84/10

(57) ABSTRACT

To facilitate management of a correspondence relationship between data divided and broadcast-transmitted on a transmission side and data divided and broadcast-received on a reception side. A wireless communication apparatus includes a broadcast transmission unit configured to broadcast-transmit divided data packetized together with an index for identifying the divided data in Bluetooth low energy (BLE). The wireless communication apparatus may further include: a unicast communication unit configured to unicast-receive the index and unicast-transmit the packetized divided data identified by the index; and a communication control unit configured to control switching between processing of broadcast-transmitting the divided data together with the index for identifying the divided data and processing of unicast-transmitting the divided data identified by the index.

### TECHNICAL FIELD

The present technology relates to a wireless communication apparatus and a wireless communication system. Specifically, the present technology relates to a wireless communication apparatus and a wireless communication system using broadcast communication and unicast communication.

### BACKGROUND ART

Some mobile communication systems provide a broadcast service on a basis of wireless communication. For example, a terminal firmware update method in a mobile broadcast system including a broadcast service distribution/adaptation unit and a broadcast service subscription management unit has been proposed (see, for example, Patent Document 1.).

### CITATION LIST

### Patent Document

Patent Document 1: Japanese Patent No. 5483375

### SUMMARY OF THE INVENTION

### Problems to be Solved by the Invention

However, in the above-described related art, when data is divided and transmitted, an index for identifying the divided data and the data are broadcast without packetizing the index and the data. For this reason, there has been a possibility that it may become difficult to manage a correspondence relationship between data divided and broadcast-transmitted on a transmission side and data divided and broadcast-received on a reception side.

The present technology has been made in view of such a situation, and an object thereof is to facilitate management of a correspondence relationship between data divided and broadcast-transmitted on a transmission side and data divided and broadcast-received on a reception side.

### Solutions to Problems

The present technology has been made to solve the above-described problems, and a first aspect thereof is a wireless communication apparatus including a broadcast transmission unit configured to broadcast-transmit divided data packetized together with an index for identifying the divided data in Bluetooth low energy (BLE). This brings about an effect that common data is collectively transmitted to a plurality of receivers while enabling a reception side to confirm the broadcast-transmitted data for each index.

Furthermore, in the first aspect, the broadcast transmission unit may repeat the broadcast transmission of the index and the data. This brings about an effect of preventing omission of reception of the broadcast-transmitted data while collectively transmitting common data to a plurality of receivers.

Furthermore, in the first aspect, the data may be firmware update data. This brings about an effect that common update data is collectively transmitted to the plurality of receivers while enabling the reception side to confirm the broadcast-transmitted update data for each index.

Furthermore, in the first aspect, the index may include information indicating a head and a rear end of the divided data. With this arrangement, there is an effect that the divided data is identified on the reception side.

Furthermore, in the first aspect, information indicating whether or not the data is commonly used or individually used by a reception destination may be added to the data. This brings about an effect that the data to be used is determined by the reception destination.

Furthermore, in the first aspect, the broadcast transmission unit may use broadcast isochronous streams (BIS) or extended advertising in the BLE for the broadcast transmission.

This brings an effect that the broadcast transmission is performed in a device in which BLE is implemented.

Furthermore, in the first aspect, the wireless communication apparatus may further include a unicast communication unit configured to unicast-receive the index and unicast-transmit packetized divided data identified by the index; and a communication control unit configured to control switching between processing of broadcast-transmitting the divided data together with the index for identifying the divided data and processing of unicast-transmitting the divided data identified by the index. This brings about an effect that common data can be collectively transmitted to the plurality of receivers and individual data is individually transmitted to the receivers.

Furthermore, in the first aspect, the communication control unit may switch to the broadcast transmission such that the data is divided for each index and transmitted, and switch to the unicast communication such that the unicast reception and the unicast transmission are performed between the broadcast transmissions divided for each index. This brings about an effect that individual data is individually transmitted to the receiver without waiting until the broadcast transmission is completed for all indexes.

Furthermore, in the first aspect, the unicast communication unit may use general attribute (GATT) or logical link control and adaptation protocol (L2CAP) in Bluetooth low energy (BLE) for the unicast communication. This brings an effect that the unicast communication is performed in a device in which BLE is implemented.

Furthermore, a second aspect is a wireless communication apparatus including a broadcast reception unit configured to broadcast-receive divided data packetized together with an index for identifying the divided data in Bluetooth low energy (BLE). This brings about an effect that common data is collectively received by a plurality of receivers while enabling a reception side to confirm the broadcast-received data for each index.

Furthermore, in the second aspect, the broadcast reception unit may repeat the broadcast reception of the index and the data. This brings about an effect of preventing omission of reception of the broadcast-received data while collectively receiving common data by the plurality of receivers.

Furthermore, in the second aspect, the data may be firmware update data. This brings about an effect that common update data is collectively received by the plurality of receivers while enabling the reception side to confirm the broadcast-received update data for each index.

Furthermore, in the second aspect, the index may include information indicating a head and a rear end of the divided data. With this arrangement, there is an effect that the divided data is identified on the reception side.

Furthermore, in the second aspect, information indicating whether or not the data is commonly used or individually used by a reception destination may be added to the data. This brings about an effect that the data to be used is determined by the reception destination.

Furthermore, in the second aspect, the broadcast reception unit may use broadcast isochronous streams (BIS) or extended advertising in the BLE for the broadcast reception. This brings an effect that the broadcast reception is performed in a device in which BLE is implemented.

Furthermore, in the second aspect, the wireless communication apparatus may further include a unicast communication unit configured to unicast-transmit the index and unicast-receive packetized divided data identified by the index; and a communication control unit configured to control switching between processing of broadcast-receiving the divided data together with the index for identifying the divided data and processing of unicast-receiving the divided data identified by the index. This brings about an effect that the common data can be collectively received by the plurality of receivers and individual data is individually received by the receivers.

Furthermore, in the second aspect, the communication control unit may switch to the broadcast reception such that the data is divided for each index and received, and switch to the unicast communication such that the unicast transmission and the unicast reception are performed between the broadcast receptions divided for each index. This brings about an effect that individual data is individually received by the receiver without waiting until the broadcast reception is completed for all indexes.

Furthermore, in the second aspect, the unicast communication unit may use general attribute (GATT) or logical link control and adaptation protocol (L2CAP) in Bluetooth low energy (BLE) for the unicast communication. This brings an effect that the unicast communication is performed in a device in which BLE is implemented.

Furthermore, a third aspect is a wireless communication system including: a transmitter configured to packetize divided data together with an index for identifying the divided data in Bluetooth low energy (BLE) and broadcast-transmit the packetized data; and a receiver configured to broadcast-receive the divided data packetized together with the index. With this arrangement, there is an effect that common data collectively transmitted from a single transmitter is collectively received by a plurality of receivers while enabling a reception side to confirm the broadcast-transmitted data for each index.

Furthermore, in the third aspect, the transmitter may include: a broadcast transmission unit configured to broadcast-transmit the data packetized together with the index, a unicast communication unit configured to unicast-receive the index and unicast-transmit the packetized data identified by the index, and a communication control unit configured to control switching between processing of broadcast-transmitting the data together with the index and processing of unicast-transmitting the data identified by the index, and the receiver may include: a broadcast reception unit configured to broadcast-receive the data packetized together with the index, a unicast communication unit configured to unicast-transmit the index and unicast-receive the packetized data identified by the index, and a communication control unit configured to control switching between processing of broadcast-receiving the data together with the index and processing of unicast-receiving the data identified by the index. This brings about an effect that common data collectively transmitted from a single transmitter can be collectively received by a plurality of receivers, and individual data transmitted from a single transmitter is individually received by the receivers.

### BRIEF DESCRIPTION OF DRAWINGS

FIG. 1 is a diagram illustrating a configuration example of a wireless communication system according to a first embodiment.

FIG. 2 is a block diagram illustrating a functional configuration example of a transmitter according to the first embodiment.

FIG. 3 is a block diagram illustrating a hardware configuration example of the transmitter according to the first embodiment.

FIG. 4 is a block diagram illustrating a functional configuration example of a receiver according to the first embodiment.

FIG. 5 is a block diagram illustrating a hardware configuration example of the receiver according to the first embodiment.

FIG. 6 is a diagram illustrating a first example of a configuration of a packet used for wireless communication according to the first embodiment.

FIG. 7 is a diagram illustrating a second example of a configuration of a packet used for the wireless communication according to the first embodiment.

FIG. 8 is a diagram illustrating a first example of data held by the receiver according to the first embodiment.

FIG. 9 is a diagram illustrating a second example of data held by the receiver according to the first embodiment.

FIG. 10 is a timing chart illustrating a broadcast transmission method in Bluetooth low energy (BLE) used for the wireless communication according to the first embodiment.

FIG. 11 is a flowchart illustrating transmission processing in the wireless communication according to the first embodiment.

FIG. 12 is a flowchart illustrating initialization processing in the transmission processing according to the first embodiment.

FIG. 13 is a flowchart illustrating broadcast transmission processing in the transmission processing according to the first embodiment.

FIG. 14 is a flowchart illustrating unicast reception processing in the transmission processing according to the first embodiment.

FIG. 15 is a flowchart illustrating unicast transmission processing in the transmission processing according to the first embodiment.

FIG. 16 is a flowchart illustrating update start command processing in the transmission processing according to the first embodiment.

FIG. 17 is a flowchart illustrating reception processing in the wireless communication according to the first embodiment.

FIG. 18 is a flowchart illustrating broadcast reception and packet analysis processing in reception processing according to the first embodiment.

FIG. 19 is a flowchart illustrating unicast reception processing in the reception processing according to the first embodiment.

FIG. 20 is a flowchart illustrating unicast transmission processing in the reception processing according to the first embodiment.

FIG. 21 is a diagram illustrating a first example of a wireless communication sequence according to the first embodiment.

FIG. 22 is a diagram illustrating a second example of a wireless communication sequence according to the first embodiment.

FIG. 23 is a diagram illustrating an example of a wireless communication sequence according to a second embodiment.

### MODE FOR CARRYING OUT THE INVENTION

Modes for carrying out the present technology (hereinafter, referred to as embodiments) will be described hereinafter. The description will be given in the following order.
1. First embodiment (example of broadcast-transmitting data together with index for identifying divided data, and unicast-transmitting data identified by index on basis of unicast reception result of index)
2. Second embodiment (example of repeating broadcast transmission of data and index identifying divided data)

### 1. First Embodiment

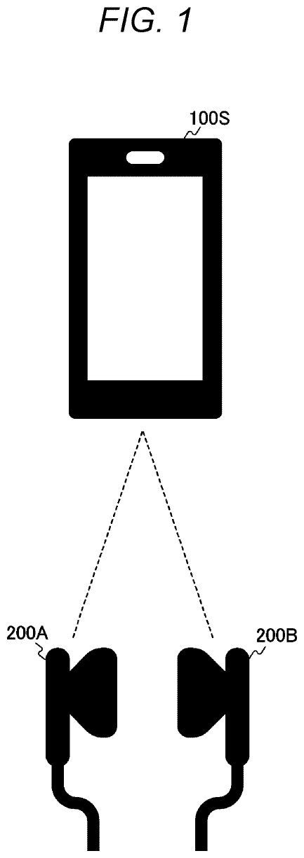

FIG. 1 is a diagram illustrating a configuration example of a wireless communication system according to a first embodiment.

In the drawing, the wireless communication system includes a smartphone 100S and wireless earphones 200A and 200B. The wireless earphones 200A and 200B can realize true wireless stereo (TWS) on a basis of wireless communication with the smartphone 100S using Bluetooth low energy (BLE).

The smartphone 100S can update firmware of the wireless earphones 200A and 200B on a basis of wireless communication. At this time, the smartphone 100S can divide firmware update data of the wireless earphones 200A and 200B and add an index to the divided update data. The smartphone 100S can packetize the update data together with the index for identifying the divided update data and broadcast-transmit the packetized data.

The wireless earphones 200A and 200B update the firmware of the wireless earphones 200A and 200B on a basis of the update data broadcast-transmitted from the smartphone 100S. At this time, the wireless earphones 200A and 200B determine whether or not there is missing of the update data broadcast-transmitted from the smartphone 100S. Then, in a case where there is missing of the broadcast-transmitted update data, the wireless earphones 200A and 200B identify an index of a missing portion of the update data. Then, the wireless earphones 200A and 200B unicast-transmit a retransmission request for the missing portion of the update data identified by the index to the smartphone 100S.

Upon unicast reception of the retransmission request for the missing portion of the update data identified by the index, the smartphone 100S unicast-transmits the missing portion of the update data identified by the index to the wireless earphones 200A and 200B.

The wireless earphones 200A and 200B update non-updated portions of the firmware of the wireless earphones 200A and 200B on a basis of the update data unicast-transmitted from the smartphone 100S.

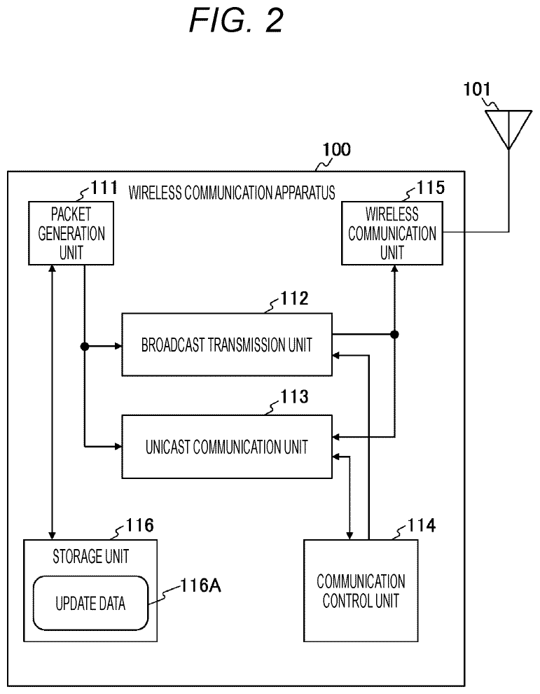

FIG. 2 is a block diagram illustrating a functional configuration example of a transmitter according to the first embodiment.

In the drawing, the wireless communication apparatus 100 performs broadcast transmission and unicast communication. At this time, the wireless communication apparatus 100 can use broadcast isochronous streams (BIS) or extended advertising in BLE for broadcasting. The wireless communication apparatus 100 can use general attribute (GATT) or logical link control and adaptation protocol (L2CAP) in BLE for unicasting. The wireless communication apparatus 100 may be the smartphone 100S.

The wireless communication apparatus 100 includes a packet generation unit 111, a broadcast transmission unit 112, a unicast communication unit 113, a communication control unit 114, a wireless communication unit 115, and a storage unit 116. The wireless communication apparatus 100 is connected to an antenna 101 via the wireless communication unit 115.

The packet generation unit 111 packetizes transmission data. The transmission data may be update data of firmware of a device capable of communicating with the wireless communication apparatus 100. The device may be the wireless earphones 200A and 200B. A packet includes a header and a payload. An index for identifying divided transmission data is stored in the header. The index may include information indicating a head and a rear end of the divided transmission data. The division of the transmission data can be performed in units of transmittable capacity. Packetization of the transmission data may be performed for each index. The payload stores firmware update data. Information indicating whether or not the update data is commonly used or individually used by a reception destination may be added to the update data.

The broadcast transmission unit 112 broadcast-transmits the transmission data packetized together with the index for identifying the divided transmission data. At this time, the broadcast transmission unit 112 may broadcast-transmit the transmission data packetized together with the index for each index. Furthermore, the broadcast transmission unit 112 may start broadcast transmission of the transmission data and the index without confirming the device capable of communicating with the wireless communication apparatus 100. Alternatively, the broadcast transmission unit 112 may start the broadcast transmission of the transmission data and the index after confirming the device capable of communicating with the wireless communication apparatus 100. At this time, the broadcast transmission unit 112 may start the broadcast transmission of the transmission data and the index when confirming a plurality of devices capable of communicating with the wireless communication apparatus 100. The broadcast transmission unit 112 may confirm whether or not a transmission destination can receive before transmission. Furthermore, the broadcast transmission unit 112 may repeat the broadcast transmission of the transmission data and the index. At this time, a number of repetitions of the broadcast transmission of the transmission data and the index may be determined in advance. Alternatively, the broadcast transmission unit 112 may change the number of repetitions of the broadcast transmission of the transmission data and the index according to a communication environment of the wireless communication apparatus 100. Alternatively, the broadcast transmission unit 112 may set the number of repetitions of the broadcast transmission of the transmission data and the index according to a number of devices capable of communicating with the wireless communication apparatus 100.

The unicast communication unit 113 unicast-receives the index for identifying the divided transmission data. Further, the unicast communication unit 113 unicast-transmits the packetized transmission data identified by the index. At this time, the unicast communication unit 113 may unicast-transmit the packetized transmission data identified by the index on a basis of a retransmission request for the transmission data identified by the index.

The communication control unit 114 controls switching between processing of broadcast-transmitting the data together with the index for identifying the divided data and processing of unicast-transmitting the data identified by the index. At this time, when the device capable of communicating with the wireless communication apparatus 100 is not confirmed, the communication control unit 114 may switch to the broadcast transmission. Alternatively, the communication control unit 114 may switch to the unicast transmission when confirming a single device capable of communicating with the wireless communication apparatus 100, and switch to the broadcast transmission when confirming a plurality of devices capable of communicating with the wireless communication apparatus 100. Alternatively, the communication control unit 114 may repeat the broadcast transmission until receiving reception completion notifications from all of the plurality of devices that has performed broadcast transmission. Alternatively, when the communication control unit 114 receives the reception completion notifications from some of the plurality of devices at the time of broadcast transmission, the communication control unit may switch to the unicast communication with respect to a device from which the reception completion notification has not received.

In the switching between the broadcast transmission and the unicast communication, the communication control unit 114 may switch to the unicast communication such that unicast reception and unicast transmission are performed between the broadcast transmissions divided for each index. With this arrangement, the unicast communication unit 113 can individually transmit data identified by the index without waiting until the broadcast transmission is completed for all indexes.

The communication control unit 114 may use a maximum number of unicast connections (for example, ten devices) and a switching threshold between broadcast transmission and unicast transmission (for example, four devices) for determining switching between the broadcast transmission and the unicast communication. The switching threshold is a threshold of a “device to which data transmission has been completed” among devices to be unicast-connected. For example, if a home speaker system including seven devices is assumed, in a case where the switching threshold is set to four devices, broadcast transmission can be performed until reception completion notifications are received from the four devices, and switching to unicast transmission can be performed when completion notifications are received from the four devices. Furthermore, the communication control unit 114 may use a reception enable/disable state (for example, whether or not broadcast reception can be performed) for each reception destination and a broadcast completion status (for example, completed or not completed) for each reception destination for determining switching between broadcast transmission and unicast communication. Furthermore, the communication control unit 114 may use a unicast transmission request packet index (for example, an L side is 1, 4, 20, and an R side is 3, 5) and a transmission completion status (for example, completed or not completed) for each reception destination for determining switching between broadcast transmission and unicast communication.

The wireless communication unit 115 converts a baseband signal to be transmitted into a radio frequency band or converts a received radio frequency signal into a baseband band.

Furthermore, the wireless communication unit 115 amplifies a transmission signal and a reception signal. The wireless communication unit 115 is connected to the antenna 101.

The storage unit 116 stores update data 116A. The storage unit 116 may be a flash memory or an SD card.

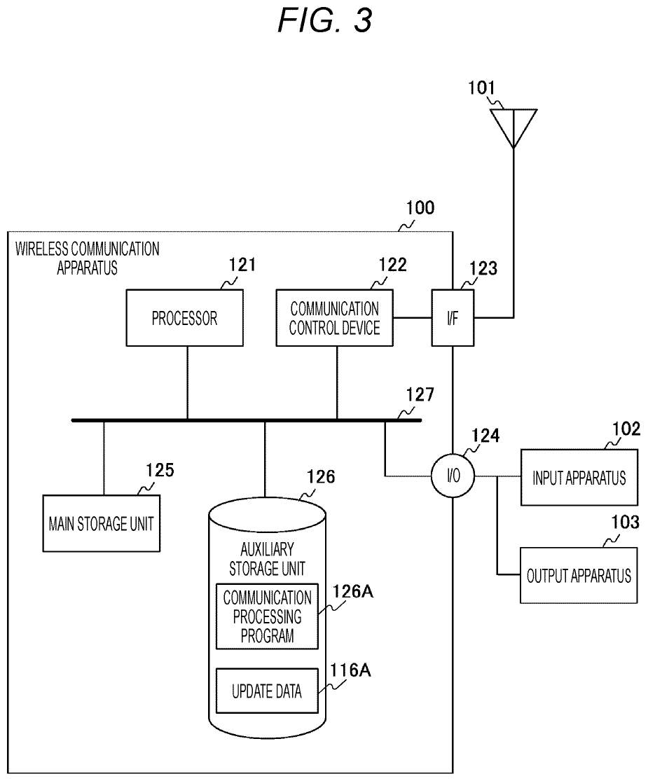

FIG. 3 is a block diagram illustrating a hardware configuration example of a transmitter according to the first embodiment.

In the drawing, the wireless communication apparatus 100 includes a processor 121, a communication control device 122, a communication interface 123, a main storage unit 125, an auxiliary storage unit 126, and an input/output interface 124. The processor 121, the communication control device 122, the communication interface 123, the main storage unit 125, the auxiliary storage unit 126, and the input/output interface 124 are mutually connected via an internal bus 127. The main storage unit 125 and the auxiliary storage unit 126 are accessible from the processor 121. The communication control device 122 is connected to the antenna 101 via the communication interface 123.

Furthermore, the wireless communication apparatus 100 is provided with an input apparatus 102 and an output apparatus 103. The input apparatus 102 and the output apparatus 103 are connected to the internal bus 127 via the input/output interface 124. The input apparatus 102 is, for example, a keyboard, a mouse, a touch panel, a card reader, or a microphone. The output apparatus 103 is, for example, a screen display apparatus (liquid crystal monitor, organic electro luminescence (EL) display, graphic card, and the like), a speaker, or a printer.

The processor 121 is hardware that manages operation control of the entire wireless communication apparatus 100. The processor 121 may be a central processing unit (CPU) or a graphics processing unit (GPU). The processor 121 may be a single-core processor or a multi-core processor. The processor 121 may include a hardware circuit (for example, a field-programmable gate array (FPGA) or an application specific integrated circuit (ASIC) ) such as an accelerator that performs a part of processing.

The main storage unit 125 can include, for example, a semiconductor memory such as a static random access memory (SRAM) or a dynamic random access memory (DRAM). The main storage unit 125 can store a program being executed by the processor 121 or can be provided with a work area for the processor 121 to execute the program.

The auxiliary storage unit 126 is a storage device having a large storage capacity, and is, for example, a flash memory or an SD card. The auxiliary storage unit 126 can hold execution files of various programs and data used for executing the programs. The auxiliary storage unit 126 can store a communication processing program 126A and the update data 116A.

The communication processing program 126A may be software that can be installed in the wireless communication apparatus 100 or may be incorporated as firmware in the wireless communication apparatus 100. The update data 116A is used to update firmware of a communication partner.

The communication control device 122 is hardware having a function of controlling communication with an outside. The communication control device 122 is connected to a communication partner via the communication interface 123. BLE can be used for the connection.

Furthermore, the communication control device 122 is connected to a network via the communication interface 123. The network may be a wide area network (WAN) such as the Internet, a local area network (LAN) such as WiFi or Ethernet (registered trademark), or a mixture of the WAN and the LAN. The network may be a cellular network.

The input/output interface 124 converts data input from the input apparatus 102 into a data format that can be processed by the processor 121, or converts data output from the processor 121 into a data format that can be processed by the output apparatus 103.

The processor 121 can perform wireless communication processing of the wireless communication apparatus 100 by reading the communication processing program 126A into the main storage unit 125 and executing the communication processing program 126A. In the wireless communication processing, broadcast transmission processing and unicast communication processing of the update data 116A using BLE can be performed. Furthermore, the wireless communication processing can include processing of generating a packet used for broadcast transmission and unicast communication. Packetization of the update data 116A can be performed for each index for identifying the divided update data 116A. Furthermore, the wireless communication processing can include switching processing between broadcast transmission and unicast communication of the update data 116A.

Note that execution of the communication processing program 126A may be shared by a plurality of processors or computers. Alternatively, the processor 121 may instruct a cloud computer or the like to execute all or a part of the communication processing program 126A via a network, and may receive the execution result.

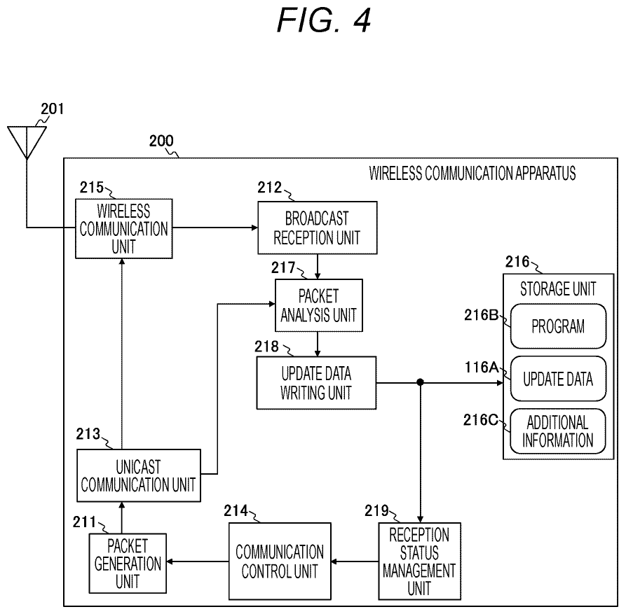

FIG. 4 is a block diagram illustrating a functional configuration example of a receiver according to the first embodiment.

In the drawing, a wireless communication apparatus 200 performs broadcast reception and unicast communication. At this time, the wireless communication apparatus 200 can use broadcast isochronous streams (BIS) or extended advertising in BLE for broadcasting. The wireless communication apparatus 200 can use general attribute (GATT) or logical link control and adaptation protocol (L2CAP) in BLE for unicasting. The wireless communication apparatus 200 may be the wireless earphones 200A and 200B, a multi-channel audio system, a beacon installed in a store, a passage, a station building, an airport, a sightseeing spot, or the like, or a mesh communication device.

The wireless communication apparatus 200 includes a packet generation unit 211, a broadcast reception unit 212, a unicast communication unit 213, a communication control unit 214, a wireless communication unit 215, and a storage unit 216. Furthermore, the wireless communication apparatus 200 includes a packet analysis unit 217, an update data writing unit 218, and a reception status management unit 219. The wireless communication apparatus 200 is connected to an antenna 201 via the wireless communication unit 215.

The packet generation unit 211 packetizes transmission data. The transmission data may be a retransmission request for update data transmitted from the wireless communication apparatus 100. Furthermore, the transmission data may include device information of the own device or may include current version information of firmware of the own device.

The broadcast reception unit 212 broadcast-receives the transmission data packetized together with an index for identifying the divided transmission data. At this time, the broadcast reception unit 212 may broadcast-receive the divided transmission data for each index. Furthermore, the broadcast reception unit 212 may start the broadcast reception of the transmission data packetized together with the index without confirming a transmission source of the transmission data.

Alternatively, the broadcast reception unit 212 may start the broadcast reception of the transmission data packetized together with the index after confirming the transmission source of the transmission data. The broadcast reception unit 212 may notify the transmission source of whether or not reception is possible. Furthermore, the broadcast reception unit 212 may repeat the broadcast reception of the transmission data packetized together with the index for each index. At this time, a number of repetitions of the broadcast reception of the transmission data packetized together with the index may be determined in advance. Alternatively, the broadcast reception unit 212 may change the number of repetitions of the broadcast reception of the transmission data and the index according to a communication environment of the wireless communication apparatus 200.

The unicast communication unit 213 unicast-transmits the index for identifying the divided transmission data. At this time, the unicast communication unit 213 may request retransmission of the transmission data identified by the index. Furthermore, the unicast communication unit 213 unicast-receives the packetized transmission data identified by the index.

The communication control unit 214 controls switching between processing of broadcast-receiving data together with an index for identifying divided data and processing of unicast-receiving the data identified by the index. At this time, the communication control unit 214 may switch to broadcast reception without confirming the transmission source of the transmission data. The communication control unit 214 may repeat the broadcast reception until the broadcast reception succeeds for all indexes. Alternatively, the communication control unit 214 may switch to the unicast reception when the broadcast reception fails for a certain index. Alternatively, the communication control unit 214 may switch to the unicast transmission when the broadcast reception fails for a certain index and perform a retransmission request for the index.

In the switching between the broadcast reception and the unicast communication, the communication control unit 214 may switch to the unicast communication such that unicast transmission and unicast reception are performed between the broadcast receptions divided for each index. With this arrangement, the unicast communication unit 213 can individually receive data identified by the index without waiting until the broadcast reception is completed for all the indexes.

The wireless communication unit 215 converts a baseband signal to be transmitted into a radio frequency band or converts a received radio frequency signal into a baseband band.

Furthermore, the wireless communication unit 215 amplifies a transmission signal and a reception signal. The wireless communication unit 215 is connected to the antenna 201.

The storage unit 216 stores the update data 116A, a program 216B, and additional information 216C. The program 216B manages processing of the entire wireless communication apparatus 200. The update data 116A is used to update the program 216B. The additional information 216C is added to the update data 116A. The additional information 216C may include version information of the update data 116A and pair information of the update data 116A. The pair information is, for example, information indicating L/R when the wireless communication apparatus 200 is mounted on the wireless earphones 200A and 200B. The storage unit 216 may be a flash memory or an SD card.

The packet analysis unit 217 analyzes a packet received by the broadcast reception unit 212 or the unicast communication unit 213. In the analysis, for example, it is possible to determine whether or not there is missing in the update data 116A received by the broadcast reception unit 212 or the unicast communication unit 213. Then, in a case where there is missing in the update data 116A, an index of a missing portion can be identified.

The update data writing unit 218 writes the update data 116A analyzed by the packet analysis unit 217 to the storage unit 216 and updates the program 216B. At this time, the update data writing unit 218 writes the update data 116A included in the packet successfully received by the broadcast reception unit 212 or the unicast communication unit 213 to the storage unit 216. On the other hand, the update data writing unit 218 can discard the update data 116A included in the packet that has failed to be received by the broadcast reception unit 212 or the unicast communication unit 213.

The reception status management unit 219 manages the reception status of the packet received by the broadcast reception unit 212 or the unicast communication unit 213 on a basis of the update data 116A written by the update data writing unit 218. The information regarding the reception status may include, for example, an unreceived packet index (for example, 1, 4, 20), a total number of packets (for example, 1024), a reception start packet index (for example, 10), and a unicast switching reception completion rate threshold (for example, 70%).

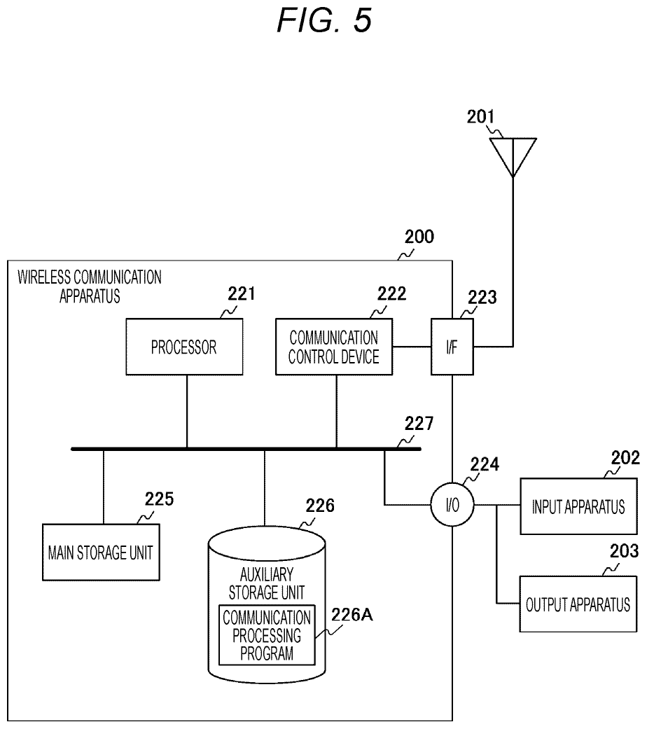

FIG. 5 is a block diagram illustrating a hardware configuration example of a receiver according to the first embodiment.

In the drawing, the wireless communication apparatus 200 includes a processor 221, a communication control device 222, a communication interface 223, a main storage unit 225, an auxiliary storage unit 226, and an input/output interface 224. The processor 221, the communication control device 222, the communication interface 223, the main storage unit 225, the auxiliary storage unit 226, and the input/output interface 224 are mutually connected via an internal bus 227. The main storage unit 225 and the auxiliary storage unit 226 are accessible from the processor 221. The communication control device 222 is connected to the antenna 201 via the communication interface 223.

Furthermore, the wireless communication apparatus 200 is provided with an input apparatus 202 and an output apparatus 203. The input apparatus 202 and the output apparatus 203 are connected to the internal bus 227 via the input/output interface 224. The input apparatus 202 is, for example, a keyboard, a mouse, a touch panel, a card reader, or a microphone. The output apparatus 203 is, for example, a screen display apparatus (liquid crystal monitor, organic EL display, graphic card, and the like), a speaker, or a printer.

The processor 221 is hardware that manages operation control of the entire wireless communication apparatus 200. The processor 221 may be a CPU or a GPU. The processor 221 may be a single-core processor or a multi-core processor. The processor 221 may include a hardware circuit (for example, FPG or ASIC) such as an accelerator that performs a part of processing.

The main storage unit 225 can include, for example, a semiconductor memory such as an SRAM or a DRAM. The main storage unit 225 can store a program being executed by the processor 221 or can be provided with a work area for the processor 221 to execute the program.

The auxiliary storage unit 226 is a storage device having a large storage capacity, and is, for example, a flash memory or an SD card. The auxiliary storage unit 226 can hold execution files of various programs and data used for executing the programs. The auxiliary storage unit 226 can store a communication processing program 226A. The communication processing program 226A may be software that can be installed in the wireless communication apparatus 200 or may be incorporated as firmware in the wireless communication apparatus 200.

The communication control device 222 is hardware having a function of controlling communication with an outside. The communication control device 222 is connected to a communication partner via the communication interface 223. BLE can be used for the connection.

The input/output interface 224 converts data input from the input apparatus 202 into a data format that can be processed by the processor 221, or converts data output from the processor 221 into a data format that can be processed by the output apparatus 203.

The processor 221 can perform wireless communication processing of the wireless communication apparatus 200 by reading the communication processing program 226A into the main storage unit 225 and executing the communication processing program 226A. In the wireless communication processing, broadcast reception processing and unicast communication processing of the update data 116A using BLE can be performed. Furthermore, the wireless communication processing can include processing of generating a packet used for unicast communication. Furthermore, the wireless communication processing can include switching processing between broadcast reception and unicast communication of the update data 116A.

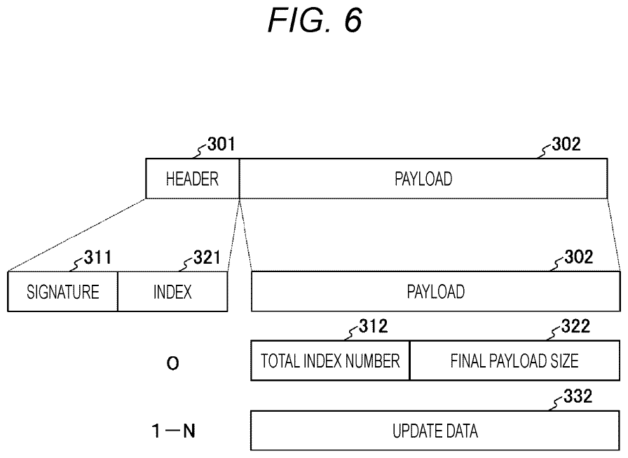

FIG. 6 is a diagram illustrating a first example of a configuration of a packet used for wireless communication according to the first embodiment.

In the drawing, entries 301 and 302 are provided in the packet. A header is stored in the entry 301, and a payload is stored in the entry 302. The entry 301 is provided with entries 311 and 321. A signature (Signature) is stored in the entry 311, and an index is stored in the entry 321. In the entry 302, entries 312 and 322 are provided to correspond to an index=0, and an entry 332 is provided to correspond to an index=1−N (N is a positive integer). The entry 312 stores a total index number and the entry 322 stores a final payload size. The entry 332 stores update data.

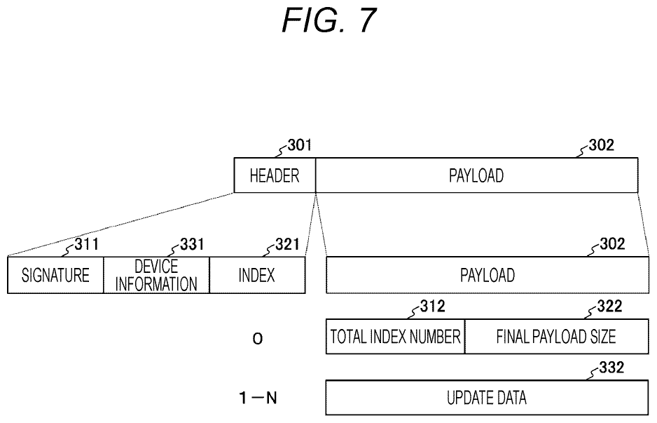

FIG. 7 is a diagram illustrating a second example of a configuration of a packet used for wireless communication according to the first embodiment.

In the drawing, an entry 331 is added to the entry 301 of the packet of FIG. 6, in this packet. The entry 331 stores device information. The rest of the configuration of the packet in the drawing is similar to the configuration of the packet in FIG. 6 described above. The device information is, for example, information regarding L/R when the update data 332 is used to update the firmware of the wireless earphones 200A and 200B.

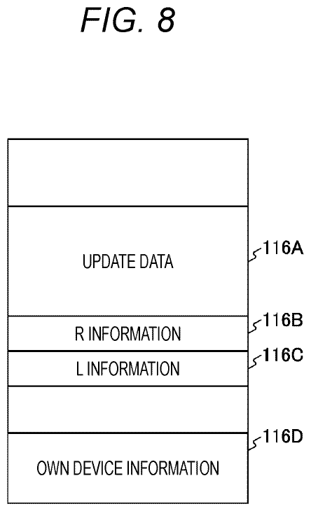

FIG. 8 is a diagram illustrating a first example of data held by the receiver according to the first embodiment. Note that in the drawing, an example in which the receiver is the wireless earphones 200A and 200B is indicated.

In the drawing, the receiver holds the update data 116A, R information 116B, L information 116C, and own device information 116D. The own device information 116D is, for example, information indicating whether or not the own device is a right wireless earphone or a left wireless earphone. The receiver can determine whether or not to use the update data 116A for L or R on a basis of the own device information 116D.

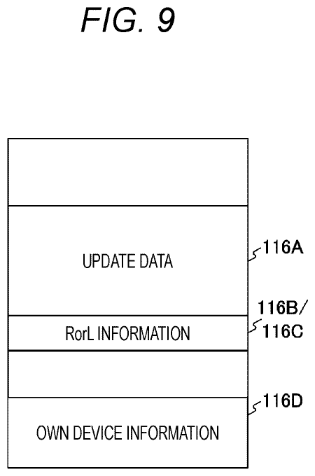

FIG. 9 is a diagram illustrating a second example of data held by the receiver according to the first embodiment. Note that in the drawing, an example in which the receiver is the wireless earphones 200A and 200B is indicated.

In the drawing, one of the R information 116B and the L information 116C is held in the receiver instead of the R information 116B and the L information 116C. The receiver can hold only information necessary for the own device on a basis of the own device information 116D.

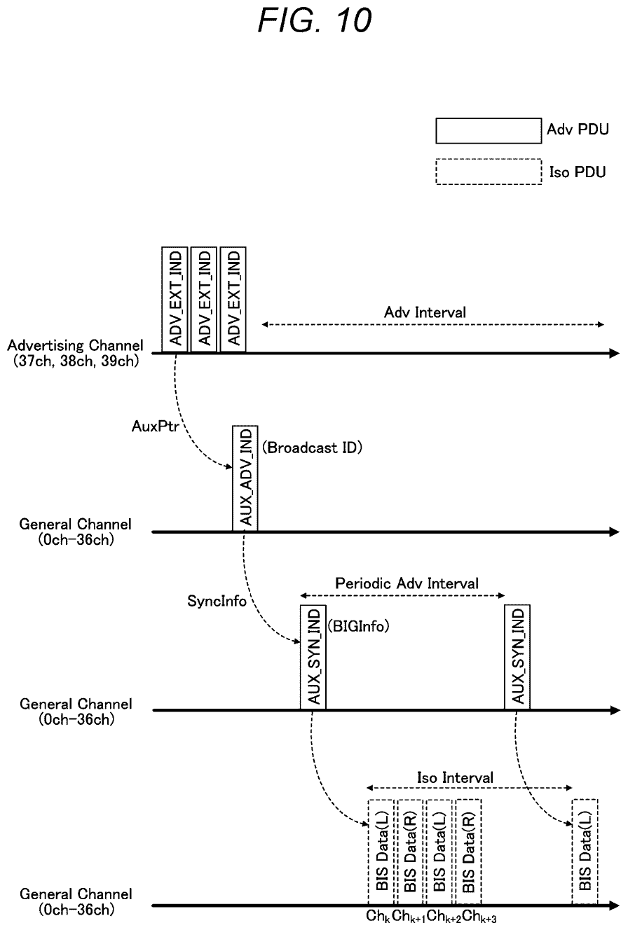

FIG. 10 is a timing chart illustrating a broadcast transmission method in BLE used for the wireless communication according to the first embodiment.

In the drawing, the wireless communication apparatus 100 scans a primary advertising channel (37ch, 38ch, 39ch) to search for ADV_EXT_IND. At this time, ADV_EXT_IND acquired by the wireless communication apparatus 100 includes AuxPtr indicating a channel number of AUX_ADV_IND. Note that Adv Interval is set to 100 ms, for example.

Next, the wireless communication apparatus 100 scans the channel on a basis of AuxPtr indicating the channel number of AUX_ADV_IND. At this time, AUX_ADV_IND acquired by the wireless communication apparatus 100 includes Local Name and Service UUID, and it can be determined that it is audio broadcast. Furthermore, a Broadcast ID for identifying the broadcast is also included.

Further, SyncInfo indicating a channel number and a timing of Periodic Advertising (AUX_SYN_IND) is also included. Note that Periodic Adv Interval is set to, for example, 10 ms.

Next, the wireless communication apparatus 100 scans the channel on a basis of SyncInfo indicating the channel number and the timing of Periodic Advertising (AUX_SYN_IND). At this time, AUX_SYN_IND acquired by the wireless communication apparatus 100 includes BIGInfo indicating a channel number and a timing of BIS Data.

Next, the wireless communication apparatus 100 scans the channel on a basis of BIGInfo indicating the channel number and the timing of BIS Data. At this time, the wireless communication apparatus 100 can acquire audio data of low complexity communications codec (LC3) by receiving BIS Data. Note that Iso Interval is set to, for example, 10 ms.

Here, the wireless communication apparatus 100 can uniquely define the data of AUX_SYN_IND to inform the wireless communication apparatus 200 that the data is firmware data on the reception side.

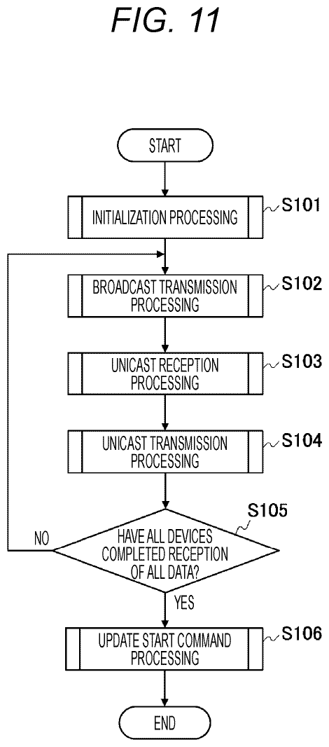

FIG. 11 is a flowchart illustrating transmission processing in the wireless communication according to the first embodiment.

In the drawing, the packet generation unit 111 performs initialization processing of packet communication (S101).

Next, the broadcast transmission unit 112 performs broadcast transmission processing of the update data 116A (S102). The broadcast transmission of the update data 116A is performed by dividing the update data 116A for each index. Then, when the broadcast transmission unit 112 broadcast-transmits the update data 116A for one index, the broadcast transmission unit moves the processing to unicast reception processing.

Next, the unicast communication unit 113 performs unicast reception processing for the update data 116A (S103). In the unicast reception processing, a unicast transmission request can be received.

Next, the unicast communication unit 113 performs unicast transmission processing of the update data 116A (S104). In the unicast transmission processing, the update data 116A identified by an index designated by the unicast transmission request can be retransmitted.

Next, the communication control unit 114 determines whether or not all devices capable of communicating with the wireless communication apparatus 100 have completed the reception of all the update data 116A (S105). In a case where all the devices capable of communicating with the wireless communication apparatus 100 have completed the reception of all the update data 116A, the communication control unit 114 advances the processing to S106. On the other hand, in a case where all the devices capable of communicating with the wireless communication apparatus 100 have not completed the reception of all the update data 116A, the communication control unit 114 returns the processing to S102.

Next, the unicast communication unit 113 performs update start command processing for all the devices capable of communicating with the wireless communication apparatus 100 (S106).

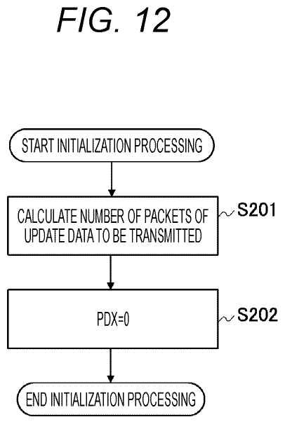

FIG. 12 is a flowchart illustrating initialization processing in the transmission processing according to the first embodiment.

In the drawing, the packet generation unit 111 calculates a number of packets of the update data 116A to be transmitted (S201).

Next, the packet generation unit 111 sets a packet index PDX to 0 (S202). The packet index PDX can indicate an index for identifying divided update data 116A.

Note that, in the initialization processing, an update target device may or may not be connected. When there are many devices to be connected, all the update target devices may be set as broadcast communication targets in order to reduce a number of times of unicast communication on the transmission side. When a number of devices to be connected is small, switching to unicast communication may be performed.

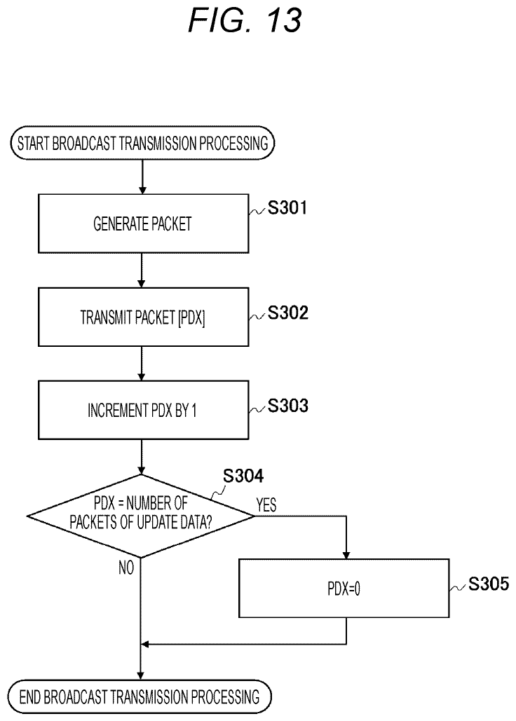

FIG. 13 is a flowchart illustrating broadcast transmission processing in the transmission processing according to the first embodiment.

In the drawing, the packet generation unit 111 generates a packet in which the update data 116A is divided for each packet index PDX and stored (S301).

Next, the broadcast transmission unit 112 broadcast-transmits a packet [PDX] storing the update data 116A identified by the packet index PDX (S302).

Next, the broadcast transmission unit 112 increments the packet index PDX by 1 (S303).

Next, the broadcast transmission unit 112 determines whether or not the packet index PDX is equal to the number of packets of the update data 116A (S304). In a case where the packet index PDX is equal to the number of packets of the update data 116A, the broadcast transmission unit 112 sets the packet index PDX to 0 and ends the broadcast transmission for the packet [PDX]. On the other hand, in a case where the packet index PDX is not equal to the number of packets of the update data 116A, the broadcast transmission unit 112 ends the broadcast transmission of the packet [PDX].

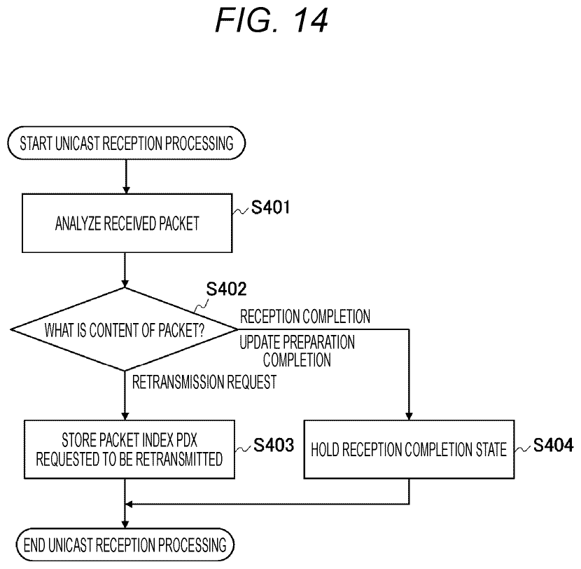

FIG. 14 is a flowchart illustrating unicast reception processing in the transmission processing according to the first embodiment.

In the drawing, the unicast communication unit 113 analyzes the received packet that has been unicast-transmitted (S401).

Next, the unicast communication unit 113 confirms a content of the received packet (S402). In a case where the content of the received packet is a retransmission request, the unicast communication unit 113 stores the packet index PDX of the update data 116A requested to be retransmitted (S403), and ends the processing. On the other hand, in a case where the content of the received packet is reception completion or update preparation completion, the unicast communication unit 113 holds the reception completion state (S404) and ends the processing.

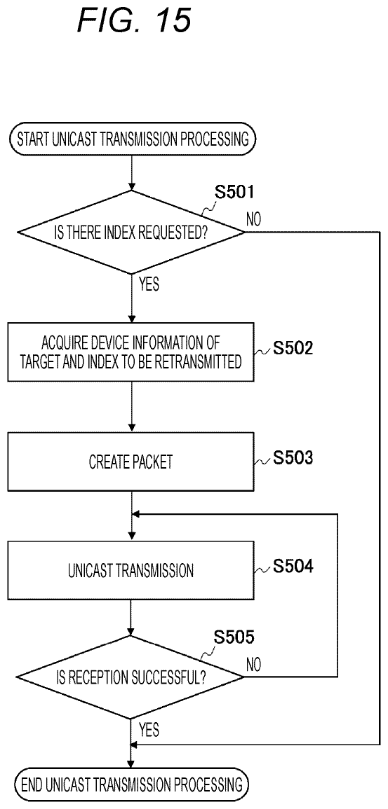

FIG. 15 is a flowchart illustrating unicast transmission processing in the transmission processing according to the first embodiment.

In the drawing, the unicast communication unit 113 determines whether or not there is the packet index PDX of the update data 116A requested to be retransmitted (S501). In a case where there is no packet index PDX of the update data 116A requested to be retransmitted, the unicast communication unit 113 ends the processing. On the other hand, in a case where there is the packet index PDX of the update data 116A requested to be retransmitted, the unicast communication unit 113 acquires device information of the device to be retransmitted and the packet index PDX of the update data 116A requested to be retransmitted (S502).

Next, the packet generation unit 111 creates a packet storing the update data 116A requested to be retransmitted (S503).

Next, the unicast communication unit 113 unicast-transmits the packet storing the update data 116A requested to be retransmitted (S504).

Next, the unicast communication unit 113 determines whether or not the reception of the unicast-transmitted packet is successful (S505). At this time, the unicast communication unit 113 can determine that the reception of the unicast-transmitted packet is successful when a reception completion notification of the unicast-transmitted packet is received from the reception side. In a case where the reception of the unicast-transmitted packet is successful, the unicast communication unit 113 ends the processing. On the other hand, in a case where the reception of the unicast-transmitted packet fails, the processing returns to S504 and the unicast transmission is repeated.

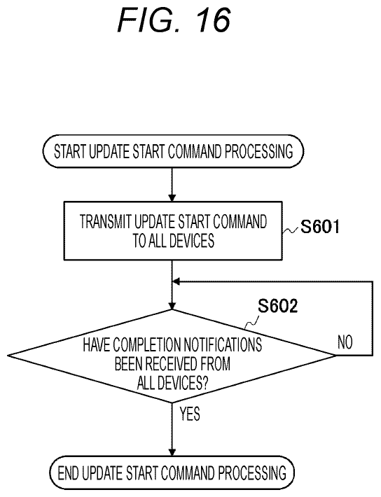

FIG. 16 is a flowchart illustrating update start command processing in the transmission processing according to the first embodiment.

In the drawing, the unicast communication unit 113 unicast-transmits an update start command to all the devices that have completed the reception of all the update data 116A (S601).

Next, the unicast communication unit 113 determines whether or not update completion notifications have been received from all the devices that have completed the reception of all the update data 116A (S602). In a case where the unicast communication unit 113 has received the update completion notifications from all the devices that have completed the reception of all the update data 116A, the processing ends. On the other hand, in a case where the unicast communication unit 113 has not received the update completion notifications from all the devices that have completed the reception of all the update data 116A, the processing returns to S602 and repeats the unicast transmission of the update start command.

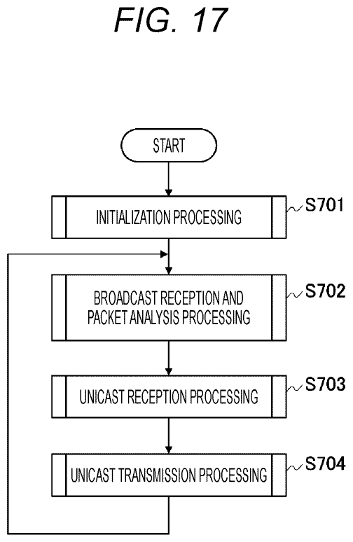

FIG. 17 is a flowchart illustrating reception processing in the wireless communication according to the first embodiment.

In the drawing, the packet generation unit 211 performs initialization processing of packet communication (S701).

Next, the broadcast reception unit 212 performs broadcast reception processing of the update data 116A, and the packet analysis unit 217 performs analysis processing of the packet received by the broadcast reception unit 212 (S702). The broadcast reception of the update data 116A is performed by dividing the update data 116A for each index. The packet analysis processing is performed for each piece of the update data 116A divided and packetized together with the index.

Next, the unicast communication unit 213 performs unicast reception processing of the update data 116A (S703). In the unicast reception processing, the update data 116A can be unicast-received on a basis of the retransmission request for the update data 116A included in the packet in which a packet error is detected.

Next, the unicast communication unit 213 performs unicast transmission processing for the update data 116A (S704). In the unicast transmission processing for the update data 116A, a unicast transmission request can be performed.

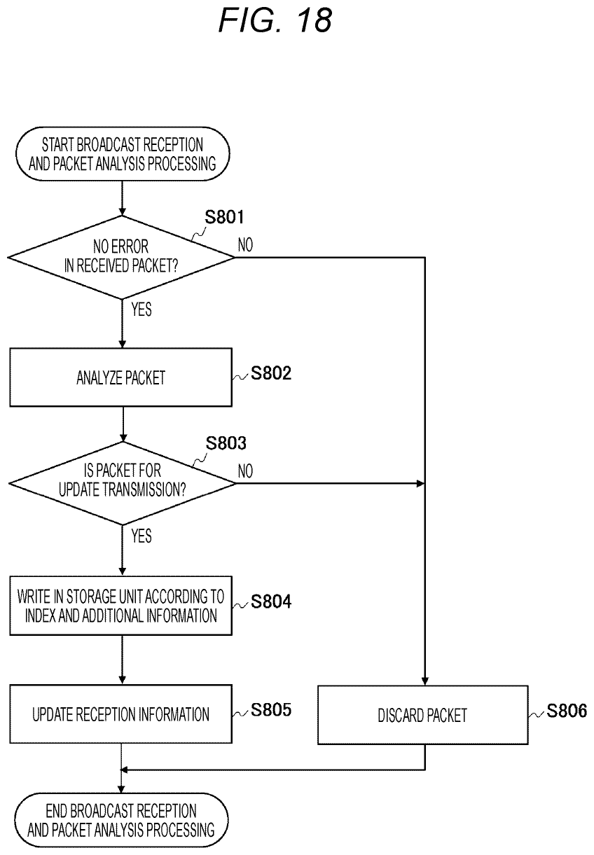

FIG. 18 is a flowchart illustrating broadcast reception and packet analysis processing in the reception processing according to the first embodiment.

In the drawing, the broadcast reception unit 212 determines whether or not there is an error in the broadcast-received packet (S801). In the determination of the packet error, a checksum or the like can be used. In a case where there is an error in the broadcast-received packet, the broadcast reception unit 212 discards the packet (S806) and ends the processing. On the other hand, in a case where there is no error in the broadcast-received packet, the broadcast reception unit 212 moves the processing to S802.

Next, the packet analysis unit 217 analyzes the broadcast-received packet. In the analysis of the packet, it is possible to confirm the index stored in the packet or confirm the content of the packet.

Next, the packet analysis unit 217 determines whether or not the broadcast-received packet is for update transmission (S803). In a case where the broadcast-received packet is not for the update transmission, the packet analysis unit 217 moves the processing to S806 and discards the packet. On the other hand, in a case where the broadcast-received packet is for the update transmission, the packet analysis unit 217 moves the processing to S804.

Next, the update data writing unit 218 writes in the storage unit 216 according to an index, additional information, and the like stored in the broadcast-received packet (S804), and updates the reception information stored in the storage unit 216 (S805). Note that the additional information is, for example, L/R information in a case where the wireless communication apparatus 200 is the wireless earphones 200A and 200B.

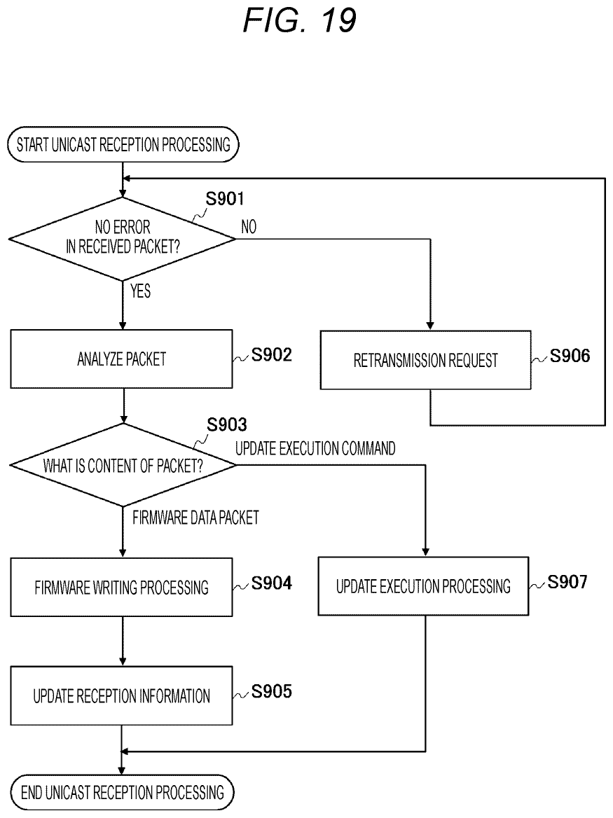

FIG. 19 is a flowchart illustrating unicast reception processing in the reception processing according to the first embodiment.

In the drawing, the unicast communication unit 213 determines whether or not there is an error in the unicast-received packet (S901). In the determination of the packet error, a checksum or the like can be used. In a case where there is an error in the unicast-received packet, the unicast communication unit 213 requests retransmission of the packet having the error and returns to S901 (S906). On the other hand, in a case where there is no error in the unicast-received packet, the unicast communication unit 213 moves the processing to S902.

Next, the packet analysis unit 217 analyzes the unicast-received packet. In the analysis of the packet, the content of the packet can be determined.

Next, the packet analysis unit 217 determines whether or not the unicast-received packet is a firmware data packet or an update execution command (S903). In a case where the unicast-received packet is a firmware data packet, the packet analysis unit 217 moves the processing to S904. On the other hand, in a case where the broadcast-received packet is an update execution command, the packet analysis unit 217 moves the processing to S907.

Next, in a case where the unicast-received packet is a firmware data packet, the update data writing unit 218 writes the firmware included in the packet to the storage unit 216 (S904) and updates the reception information stored in the storage unit 216 (S905). On the other hand, in a case where the unicast-received packet is an update execution command, the update data writing unit 218 updates the firmware stored in the storage unit 216 (S907).

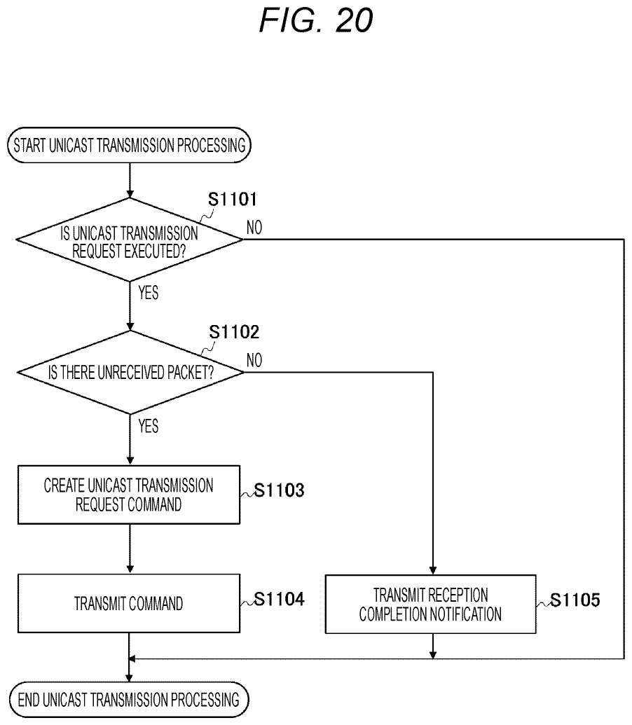

FIG. 20 is a flowchart illustrating unicast transmission processing in the reception processing according to the first embodiment.

In the drawing, the unicast communication unit 213 determines whether or not to execute a unicast transmission request (S1101). Note that an execution condition of the unicast transmission request may be determined, for example, on a basis of a data reception rate or on a basis of a number of laps of broadcast transmission. In a case where the unicast transmission request is not executed, the unicast communication unit 213 ends the processing.

On the other hand, in a case where the unicast transmission request is executed, the unicast communication unit 213 determines whether or not there is an unreceived packet (S1102). In a case where there is an unreceived packet, the unicast communication unit 213 creates a unicast transmission request command (S1103). Note that in the unicast transmission request, all the packets may be requested at a time, or may be requested one by one.

Next, the unicast communication unit 213 unicast-transmits the unicast transmission request command (S1104), and ends the processing.

On the other hand, in a case where there is no unreceived packet, the unicast communication unit 213 unicast-transmits a reception completion notification (S1105), and ends the processing.

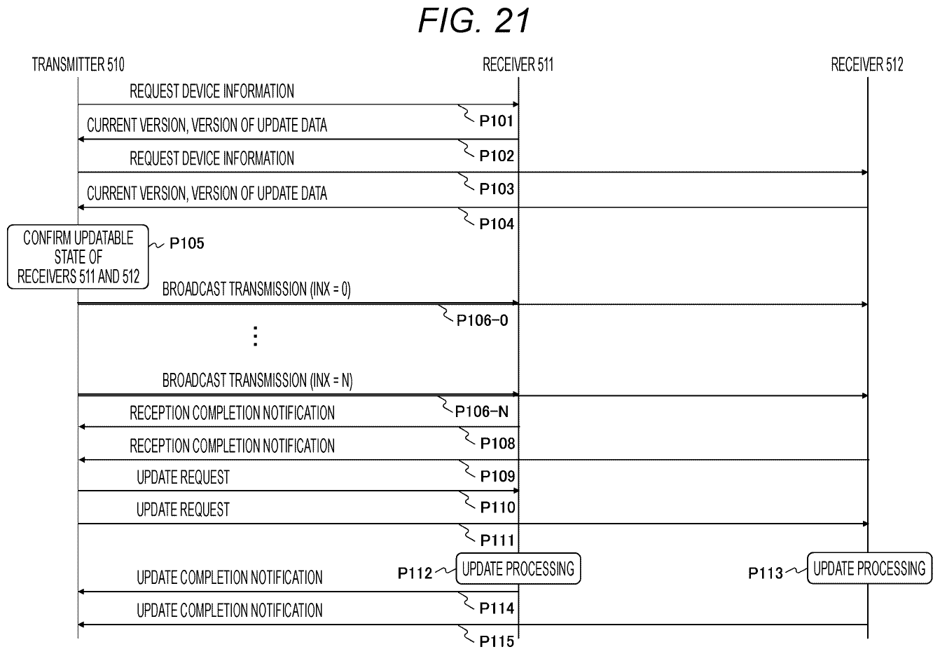

FIG. 21 is a diagram illustrating a first example of a wireless communication sequence according to the first embodiment. Note that the transmitter 510 can use the wireless communication apparatus 100, and the receivers 511 and 512 can use the wireless communication apparatus 200. Furthermore, in the drawing, a case where the transmitter 510 communicates with two receivers 511 and 512 is taken as an example, but the transmitter 510 may communicate with three or more receivers.

In the drawing, the transmitter 510 requests device information of the receiver 511 and acquires the device information of the receiver 511 (P101).

Next, the receiver 511 unicast-transmits a current version of the firmware of the receiver 511 and a version of the update data to the transmitter 510 (P102).

Next, the transmitter 510 requests device information of the receiver 512 and acquires the device information of the receiver 512 (P103).

Next, the receiver 512 unicast-transmits a current version of the firmware of the receiver 512 and a version of the update data to the transmitter 510 (P104).

Next, the transmitter 510 confirms an updatable state of each of the receivers 511 and 512 on a basis of the current version of the firmware and the version of the update data acquired from each of the receivers 511 and 512 (P105).

Next, the transmitter 510 broadcast-transmits, for each of the indexes INX=0 to N, update data divided and packetized for each of indexes INX=0 to N (P106-0 to P106-N). At this time, each of the receivers 511 and 512 broadcast-receives, for each of the indexes INX=0 to N, the update data divided and packetized for each of the indexes INX=0 to N.

Next, when the reception of the update data divided and packetized for each of the indexes INX=0 to N is completed, each of the receivers 511 and 512 unicast-transmits a reception completion notification to the transmitter 510 (P108, P109).

Next, the transmitter 510 unicast-transmits an update request for firmware of each of the receivers 511 and 512 to each of the receivers 511 and 512 (P110, P111).

Next, when receiving the firmware update request from the transmitter 510, each of the receivers 511 and 512 executes firmware update processing of each of the receivers 511 and 512 (P112, P113).

Next, when each of the receivers 511 and 512 executes the firmware update processing of each of the receivers 511 and 512, each of the receivers 511 and 512 unicast-transmits an update completion notification to the transmitter 510 (P114, P115).

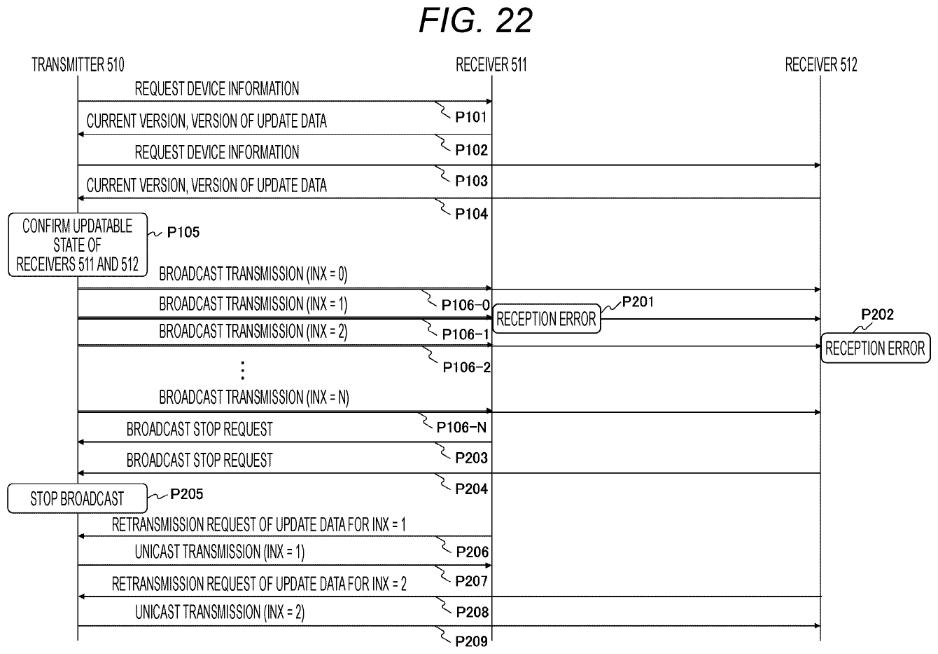

FIG. 22 is a diagram illustrating a second example of a wireless communication sequence according to the first embodiment.

In the drawing, it is assumed that each of the receivers 511 and 512 broadcast-receives, for each of the indexes INX=0 to N, the update data divided and packetized for each of the indexes INX=0 to N. At this time, it is assumed that a reception error of update data packetized for an index INX=1 has occurred in the receiver 511 (P201). It is assumed that a reception error of update data packetized for an index INX=2 has occurred in the receiver 512 (P202).

At this time, each of the receivers 511 and 512 unicast-transmits an update data broadcast stop request to the transmitter 510 (P203, P204).

When receiving the update data broadcast stop request, the transmitter 510 stops the broadcast transmission of the update data (P205).

Next, the receiver 511 unicast-transmits a retransmission request for the update data for the index INX=1 to the transmitter 510 (P206).

Next, upon receiving the retransmission request for the update data for the index INX=1 from the receiver 511, the transmitter 510 unicast-transmits the update data packetized for the index INX=1 to the receiver 511 (P207).

Next, the receiver 512 unicast-transmits a retransmission request for the update data for the index INX=2 to the transmitter 510 (P208).

Next, upon receiving the retransmission request for the update data for the index INX=2 from the receiver 512, the transmitter 510 unicast-transmits the update data packetized for the index INX=2 to the receiver 512 (P209).

As described above, in the first embodiment described above, the transmitter 510 packetizes divided update data together with the index and broadcast-transmits the packetized data, and unicast-transmits the update data on a basis of the retransmission request designated by the index. With this arrangement, the transmitter 510 can complete the reception of the update data for all the indexes without repeating the broadcast transmission of the update data until the reception succeeds for all the indexes. Therefore, it is possible to complete the update of the plurality of receivers 511 and 512 while suppressing an increase in a band occupancy rate at the time of transmitting the update data.

### 2. Second Embodiment

In the first embodiment described above, the transmitter 510 packetizes divided update data together with an index and broadcast-transmits the packetized data, and unicast-transmits the update data on a basis of a retransmission request designated by the index. In the second embodiment, the transmitter 510 repeatedly broadcast-transmits a packet obtained by packetizing the divided update data together with the index for each index.

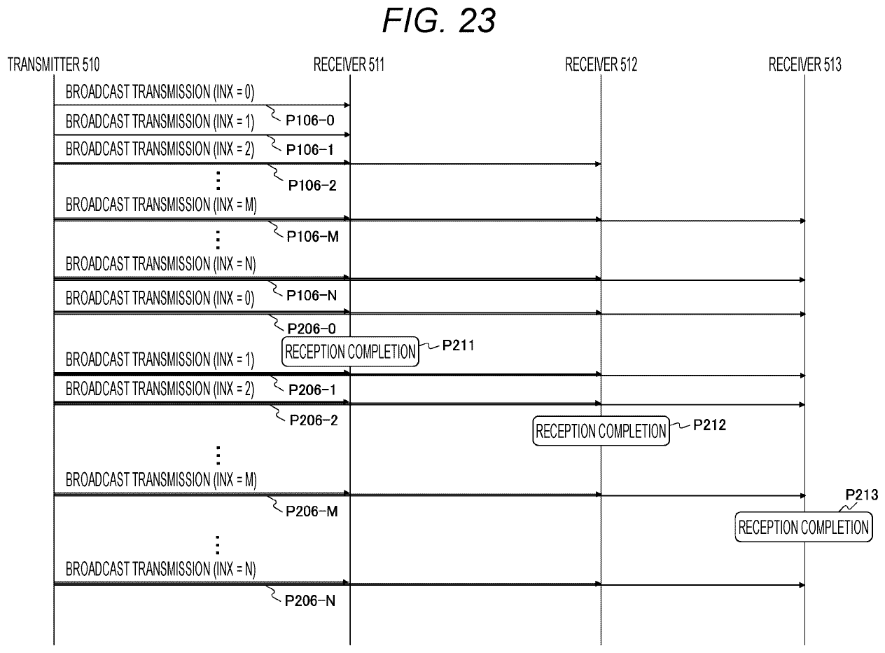

FIG. 23 is a diagram illustrating an example of a wireless communication sequence according to a second embodiment. Note that the transmitter 510 can use the wireless communication apparatus 100, and the receivers 511 to 513 can use the wireless communication apparatus 200. Furthermore, in the drawing, a case where the transmitter 510 communicates with three receivers 511 to 513 is taken as an example, but the transmitter 510 may communicate with four or more receivers.

In the drawing, the transmitter 510 broadcast-transmits, for each of the indexes INX=0 to N, update data divided and packetized for each of indexes INX=0 to N (P106-0 to P106-N). Furthermore, the transmitter 510 broadcast-transmits, for each of the indexes INX=0 to N, the update data divided and packetized for each of the indexes INX=0 to N again (P206-0 to P206-N). Note that a number of repetitions of the broadcast transmission for each of the indexes INX=0 to N may be 3 or more.

At this time, the receiver 511 sequentially broadcast-receives the update data packetized for each of indexes INX=0, 1, 2, . . . , M, . . . , N, and 0, 1, and 2 and completes the reception of the update data (P211). Note that M is an integer of 0<M<N.

Furthermore, the receiver 512 sequentially broadcast-receives the update data packetized for each of indexes INX=2, . . . , M, . . . , N, 0, 1, and 2 and completes the reception of the update data (P212).

Furthermore, the receiver 513 sequentially broadcast-receives the update data packetized for each of indexes INX=M, . . . , N, 0, 1, 2, . . . , and M and completes the reception of the update data (P213).

Note that the transmitter 510 may unicast-transmit the update data from each of the receivers 511 to 513 on a basis of a retransmission request from each of the receivers 511 to 513. At this time, the transmitter 510 may perform unicast-transmission between the broadcast transmissions of the update data for each of the indexes INX=0 to N.

As described above, in the second embodiment described above, the transmitter 510 repeatedly broadcast-transmits a packet obtained by packetizing divided update data together with the index for each index. With this arrangement, the transmitter 510 can collectively transmit common update data to the plurality of receivers 511 and 512 while enabling each of the receivers 511 and 512 to confirm the broadcast-transmitted update data for each index. Therefore, it is possible to reduce the band occupancy rate at the time of transmitting the update data as compared with a method of individually transmitting the update data to the plurality of receivers 511 and 512.

Furthermore, it is possible to facilitate management of the correspondence relationship between the update data divided and broadcast-transmitted by the transmitter 510 and the update data divided and broadcast-received by the receivers 511 and 512.

Note that the transmitter 510 may broadcast-transmit the update data from all the receivers 511 to 513, or may broadcast-transmit the update data to some receivers and unicast-transmit the update data to other receivers. For example, assuming that the transmitter 510 transmits the update data to one hundred receivers, the transmitter may broadcast-transmit the update data to ninety receivers and unicast-transmit the update data to the remaining ten receivers. At this time, the communication control unit 114 may switch between the broadcast transmission and the unicast transmission on a basis of a switching threshold between the broadcast transmission and the unicast transmission.

Note that in the above embodiments, the firmware update data is taken as an example of the data packetized together with the index and broadcast-transmitted. In addition, the data packetized together with the index and broadcast-transmitted may be voice guidance, simple firmware loaded and executed at a certain point, or data used for factory writing. Furthermore, the data packetized together with the index and broadcast-transmitted may be data or a program for operating a drone, an industrial robot, or the like.

Note that the embodiments described above are examples for embodying the present technology, and the matters in the embodiments and the matters identifying the invention in the claims have correspondences. Similarly, the matters identifying the invention in the claims and the matters with the same names in the embodiments of the present technology have correspondences. The present technology, however, is not limited to the embodiments, and can be implemented by modifying the embodiments in various ways without departing from the scope thereof. Furthermore, the effects described in the present specification are merely examples and not restrictive, and other effects may also be produced.

Note that the present technology may also have the following configurations.
(1) A wireless communication apparatus including:
a broadcast transmission unit configured to broadcast-transmit divided data packetized together with an index for identifying the divided data in Bluetooth low energy (BLE).
(2) The wireless communication apparatus according to (1), in which
the broadcast transmission unit repeats the broadcast transmission of the index and the data.
(3) The wireless communication apparatus according to (1) or (2), in which
the data is firmware update data.
(4) The wireless communication apparatus according to any one of (1) to (3), in which
the index includes information indicating a head and a rear end of the divided data.
(5) The wireless communication apparatus according to any one of (1) to (4), in which
information indicating whether or not the data is commonly used or individually used by a reception destination is added to the data.
(6) The wireless communication apparatus according to any one of (1) to (5), in which
the broadcast transmission unit uses broadcast isochronous streams (BIS) or extended advertising in the BLE for the broadcast transmission.
(7) The wireless communication apparatus according to any one of (1) to (6), further including:
a unicast communication unit configured to unicast-receive the index and unicast-transmit the packetized divided data identified by the index; and
a communication control unit configured to control switching between processing of broadcast-transmitting the divided data together with the index for identifying the divided data and processing of unicast-transmitting the divided data identified by the index.
(8) The wireless communication apparatus according to (7), in which
the communication control unit
switches to the broadcast transmission such that the data is divided for each index and transmitted, and
switches to the unicast communication such that the unicast reception and the unicast transmission are performed between the broadcast transmissions divided for each index.
(9) The wireless communication apparatus according to (7) or (8), in which
the unicast communication unit uses general attribute (GATT) or logical link control and adaptation protocol (L2CAP) in Bluetooth low energy (BLE) for the unicast communication.
(10) A wireless communication apparatus including: a broadcast reception unit configured to broadcast-receive divided data packetized together with an index for identifying the divided data in Bluetooth low energy (BLE).
(11) The wireless communication apparatus according to (10), in which
the broadcast reception unit repeats the broadcast reception of the index and the data.
(12) The wireless communication apparatus according to (10) or (11), in which
the data is firmware update data.
(13) The wireless communication apparatus according to any one of (10) to (12), in which
the index includes information indicating a head and a rear end of the divided data.
(14) The wireless communication apparatus according to any one of (10) to (13), in which
information indicating whether or not the data is commonly used or individually used by a reception destination is added to the data.
(15) The wireless communication apparatus according to any one of (10) to (14), in which
the broadcast reception unit uses broadcast isochronous streams (BIS) or extended advertising in the BLE for the broadcast reception.
(16) The wireless communication apparatus according to any one of (10) to (15), further including:
a unicast communication unit configured to unicast-transmit the index and unicast-receive packetized divided data identified by the index; and
a communication control unit configured to control switching between processing of broadcast-receiving the divided data packetized together with the index for identifying the divided data and processing of unicast-receiving the divided data identified by the index.
(17) The wireless communication apparatus according to (16), in which
the communication control unit
switches to the broadcast reception such that the data is divided for each index and received, and
switches to the unicast communication such that the unicast transmission and the unicast reception are performed between the broadcast receptions divided for each index.
(18) The wireless communication apparatus according to (16) or (17), in which
the unicast communication unit uses general attribute (GATT) or logical link control and adaptation protocol (L2CAP) in Bluetooth low energy (BLE) for the unicast communication.
(19) A wireless communication system including:
a transmitter configured to packetize divided data together with an index for identifying the divided data in Bluetooth low energy (BLE) and broadcast-transmit the packetized data; and
a receiver configured to broadcast-receive the divided data packetized together with the index.
(20) The wireless communication system according to (19), in which
the transmitter includes:
a broadcast transmission unit configured to broadcast-transmit the data packetized together with the index,
a unicast communication unit configured to unicast-receive the index and unicast-transmit the packetized data identified by the index, and
a communication control unit configured to control switching between processing of broadcast-transmitting the data together with the index and processing of unicast-transmitting the data identified by the index, and
the receiver includes:
a broadcast reception unit configured to broadcast-receive the data packetized together with the index,
a unicast communication unit configured to unicast-transmit the index and unicast-receive the packetized data identified by the index, and
a communication control unit configured to control switching between processing of broadcast-receiving the data together with the index and processing of unicast-receiving the data identified by the index.

### REFERENCE SIGNS LIST

100S Smartphone
200A, 200B Wireless earphone
100, 200 Wireless communication apparatus
101, 201 Antenna
111, 211 Packet generation unit
112 Broadcast transmission unit
113, 213 Unicast communication unit
114, 214 Communication control unit
115, 215 Wireless communication unit
116, 216 Storage unit
116A Update data
216B Program
216C Additional information
212 Broadcast reception unit
217 Packet analysis unit
218 Update data writing unit
219 Reception status management unit

1. A wireless communication apparatus comprising:
a broadcast transmission unit configured to broadcast-transmit divided data packetized together with an index for identifying the divided data in Bluetooth low energy (BLE).

2. The wireless communication apparatus according to claim 1, wherein
the broadcast transmission unit repeats the broadcast transmission of the index and the data.

3. The wireless communication apparatus according to claim 1, wherein
the data is firmware update data.

4. The wireless communication apparatus according to claim 1, wherein
the index includes information indicating a head and a rear end of the divided data.

5. The wireless communication apparatus according to claim 1, wherein
information indicating whether or not the data is commonly used or individually used by a reception destination is added to the data.

6. The wireless communication apparatus according to claim 1, wherein
the broadcast transmission unit uses broadcast isochronous streams (BIS) or extended advertising in the BLE for the broadcast transmission.

7. The wireless communication apparatus according to claim 1, further comprising:
a unicast communication unit configured to unicast-receive the index and unicast-transmit the packetized divided data identified by the index; and
a communication control unit configured to control switching between processing of broadcast-transmitting the divided data together with the index for identifying the divided data and processing of unicast-transmitting the divided data identified by the index.

8. The wireless communication apparatus according to claim 7, wherein
the communication control unit
switches to the broadcast transmission such that a packet in which the data is divided for each index is transmitted, and
switches to the unicast communication such that the unicast reception and the unicast transmission are performed between the broadcast transmissions divided for each index.

9. The wireless communication apparatus according to claim 8, wherein
the unicast communication unit uses general attribute (GATT) or logical link control and adaptation protocol (L2CAP) in Bluetooth low energy (BLE) for the unicast communication.

10. A wireless communication apparatus comprising:
a broadcast reception unit configured to broadcast-receive divided data packetized together with an index for identifying the divided data in Bluetooth low energy (BLE).

11. The wireless communication apparatus according to claim 10, wherein
the broadcast reception unit repeats the broadcast reception of the index and the data.

12. The wireless communication apparatus according to claim 10, wherein
the data is firmware update data.

13. The wireless communication apparatus according to claim 10, wherein
the index includes information indicating a head and a rear end of the divided data.

14. The wireless communication apparatus according to claim 10, wherein
information indicating whether or not the data is commonly used or individually used by a reception destination is added to the data.

15. The wireless communication apparatus according to claim 10, wherein
the broadcast reception unit uses broadcast isochronous streams (BIS) or extended advertising in the BLE for the broadcast reception.

16. The wireless communication apparatus according to claim 10, further comprising:
a unicast communication unit configured to unicast-transmit the index and unicast-receive packetized divided data identified by the index; and
a communication control unit configured to control switching between processing of broadcast-receiving the divided data packetized together with the index for identifying the divided data and processing of unicast-receiving the divided data identified by the index.

17. The wireless communication apparatus according to claim 16, wherein
the communication control unit
switches to the broadcast reception such that the data is divided for each index and received, and
switches to the unicast communication such that the unicast transmission and the unicast reception are performed between the broadcast receptions divided for each index.

18. The wireless communication apparatus according to claim 17, wherein
the unicast communication unit uses general attribute (GATT) or logical link control and adaptation protocol (L2CAP) in Bluetooth low energy (BLE) for the unicast communication.

19. A wireless communication system comprising:
a transmitter configured to packetize divided data together with an index for identifying the divided data in Bluetooth low energy (BLE) and broadcast-transmit the packetized data; and
a receiver configured to broadcast-receive the divided data packetized together with the index.

20. The wireless communication system according to claim 19, wherein
the transmitter includes:
a broadcast transmission unit configured to broadcast-transmit the data packetized together with the index,
a unicast communication unit configured to unicast-receive the index and unicast-transmit the packetized data identified by the index, and
a communication control unit configured to control switching between processing of broadcast-transmitting the data together with the index and processing of unicast-transmitting the data identified by the index, and
the receiver includes:
a broadcast reception unit configured to broadcast-receive the data packetized together with the index,
a unicast communication unit configured to unicast-transmit the index and unicast-receive the packetized data identified by the index, and
a communication control unit configured to control switching between processing of broadcast-receiving the data together with the index and processing of unicast-receiving the data identified by the index.
